(19) United States
(12) Patent Application Publication
(10) Pub. No.: US 2024/0186059 A1
(43) Pub. Date: Jun. 6, 2024

(54) COIL COMPONENT

(71) Applicant: SAMSUNG ELECTRO-MECHANICS CO., LTD., Suwon-si (KR)

(72) Inventors: Mi Geum KIM, Suwon-si (KR); Jong Eun PARK, Suwon-si (KR); Sang Ik CHO, Suwon-si (KR); Mi Jung PARK, Suwon-si (KR); Yong Su LEE, Suwon-si (KR)

(73) Assignee: SAMSUNG ELECTRO-MECHANICS CO., LTD., Suwon-si (KR)

(21) Appl. No.: 18/207,372

(22) Filed: Jun. 8, 2023

(30) Foreign Application Priority Data
Dec. 6, 2022 (KR) 10-2022-0168613

(51) Int. Cl. H01F 27/29; H01F 17/00; H01F 17/04; H01F 27/32

(52) U.S. Cl. CPC H01F 27/292; H01F 17/0013; H01F 17/04; H01F 27/324; H01F 2017/002; H01F 2017/048

(57) ABSTRACT

A coil component includes a body having a first surface and a second surface opposing each other in a first direction, a support member disposed in the body, the support member having a first surface and a second surface opposing each other, a coil disposed on the support member, a pad portion disposed on the first surface of the support member to be connected to the coil, an external electrode disposed on the first surface of the body, and a via electrode connecting the pad portion and the external electrode to each other.

### CROSS-REFERENCE TO RELATED APPLICATION (S)

This application claims benefit of priority to Korean Patent Application No. 10-2022-0168613 filed on Dec. 6, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in electronic devices along with a resistor and a capacitor.

As electronic devices are gradually becoming smaller and implemented with high-performance, numbers of electronic parts used in electronic devices are increasing while the electronic parts are being miniaturized.

In order to miniaturize the coil component, there is demand for a coil component having a structure in which external electrodes are disposed only on the lower surface and external electrodes and coils are connected through via electrodes.

### RELATED ART DOCUMENT

### Patent Document

Patent Document 1: Japanese Patent Application Publication No. 2021-068841

### SUMMARY

An aspect of the present disclosure is to provide a coil component including an external electrode disposed on only a lower surface thereof, the coil component having an increased effective volume and reduced R_{dc}, as compared to another coil component having the same size.

Another aspect of the present disclosure is to easily form a via electrode for connection between an external electrode and a coil by pre-disposing a pad portion on a lower surface of a support member.

Another aspect of the present disclosure is to improve the filling quality of a via electrode filled in a via hole.

According to an aspect of the present disclosure, a coil component includes a body having a first surface and a second surface opposing each other in a first direction, a support member disposed in the body, the support member having a first surface and a second surface opposing each other, a coil disposed on the support member, a pad portion disposed on the first surface of the support member to be connected to the coil, an external electrode disposed on the first surface of the body, and a via electrode connecting the pad portion and the external electrode to each other.

According to another aspect of the present disclosure, a coil component includes a body having a first surface and a second surface opposing each other in a first direction, the body further having a third surface connecting the first and second surfaces of the body to each other; a support member disposed in the body, the support member having a first surface and a second surface opposing each other; a coil disposed on the first and second surfaces of the support member; and a first external electrode and a second external electrode disposed on the first surface of the body, wherein the coil includes a first straight portion and a second straight portion respectively extending from opposing ends of the coil towards the third surface of the body, and ends of the first and second straight portions are connected to the first and second external electrodes through first and second via electrodes, respectively.

According to still another aspect of the present disclosure, a coil component includes a body having a first surface and a second surface opposing each other in a first direction; a support member disposed in the body; a coil disposed on the support member; an external electrode disposed on the first surface of the body; and a via electrode connecting the coil and the external electrode to each other, wherein the via electrode includes a metal layer and an insulating resin layer.

According to example embodiments of the present disclosure, an external electrode may be disposed on a mounting surface of a coil component, thereby increasing an effective volume of the coil component and reducing R_{dc} of the coil component, as compared to another coil component having the same size.

According to example embodiments of the present disclosure, a via hole for disposing a via electrode may be processed to a predetermined depth, thereby improving process efficiency and increasing connection reliability between a coil and an external electrode.

According to example embodiments of the present disclosure, the filling quality of a via electrode filled in a via hole may be improved.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to a first example embodiment of the present disclosure;

FIG. 2 is a lower perspective view of FIG. 1;

FIG. 3 is an assembly view of FIG. 1;

FIG. 4 is a cross-sectional view a taken along line I-I′ in FIG. 1;

FIG. 5 is a cross-sectional view taken along line II-II′ of FIG. 1;

FIG. 6 is a cross-sectional view taken along line III-III′ of FIG. 1;

FIG. 7 is a bottom view of FIG. 1;

FIG. 8 schematically illustrates a coil component according to a second example embodiment of the present disclosure, and is a view corresponding to FIG. 4; and

FIG. 9 illustrates a coil component according to a third example embodiment of the present disclosure, and is a view corresponding to FIG. 4.

### DETAILED DESCRIPTION

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which the other element is interposed between the elements such that the elements are also in contact with the other component.

The size and thickness of each element illustrated in the drawings is arbitrarily represented for ease of the description, but the present disclosure is not necessarily limited to those illustrated herein.

In the drawings, a T direction may be defined as a first direction or a thickness direction, a W direction may be defined as a second direction or a width direction, and an L direction may be defined as a third direction or a length direction.

Hereinafter, a coil component according to an example embodiment of the present disclosure will be described in detail with reference to the accompanying drawings, and in the description with reference to the accompanying drawings, the same or corresponding components are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, and the like.

### First Example Embodiment

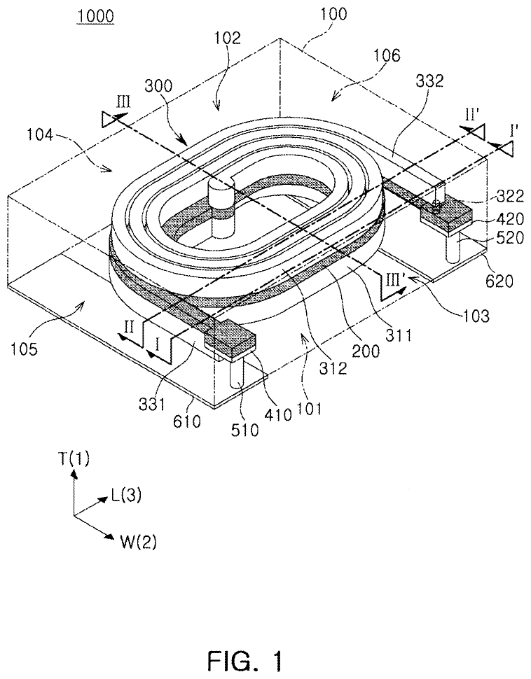

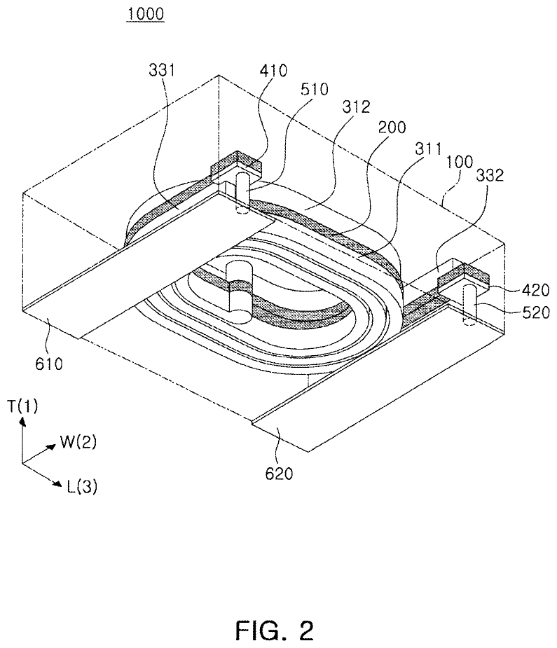

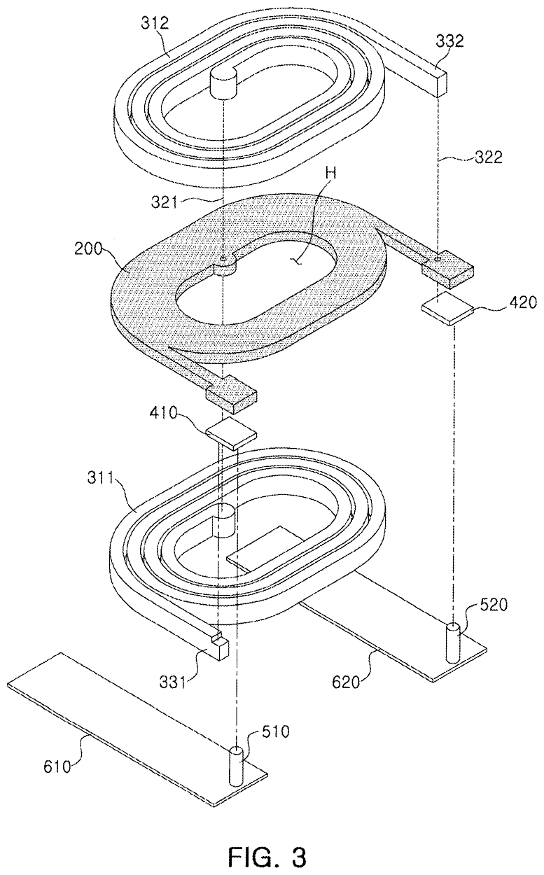

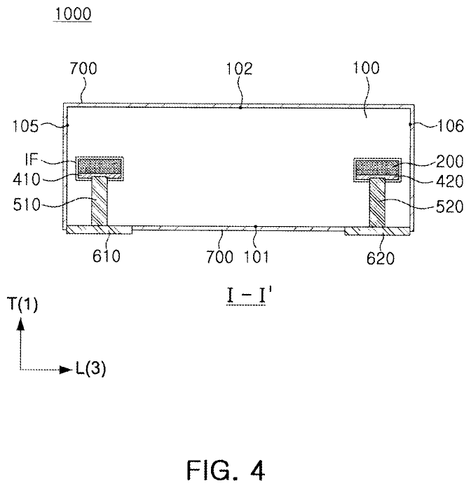

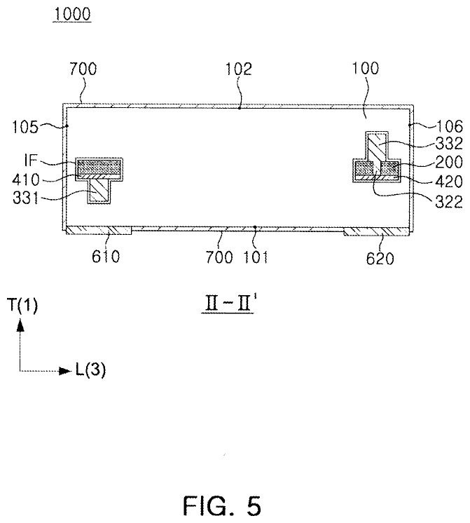

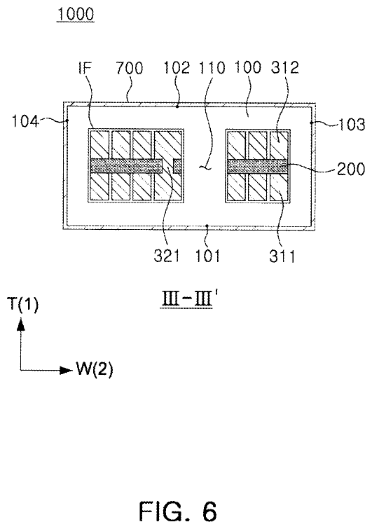

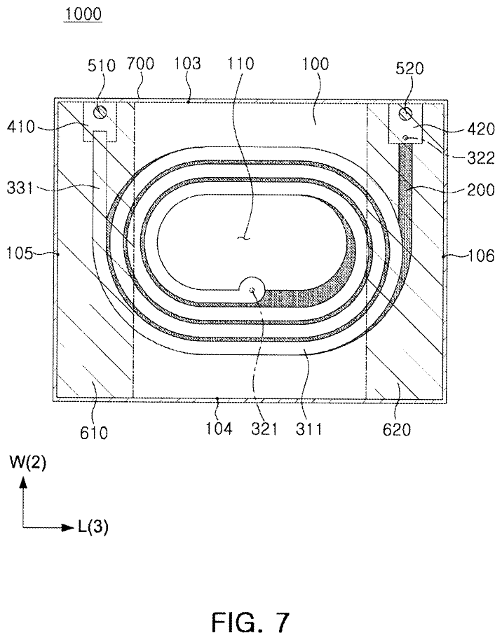

FIG. 1 is a schematic perspective view of a coil component according to a first example embodiment of the present disclosure. FIG. 2 is a lower perspective view of FIG. 1. FIG. 3 is an assembly view of FIG. 1. FIG. 4 is a cross-sectional view a taken along line I-I′ in FIG. 1. FIG. 5 is a cross-sectional view taken along line II-II′ of FIG. 1. FIG. 6 is a cross-sectional view taken along line III-III′ of FIG. 1. FIG. 7 is a bottom view of FIG. 1.

In FIGS. 1 to 3, an insulating layer 700 on a body 100 appliable to the present example embodiment may be omitted in order to more clearly illustrate coupling between components.

Referring to FIGS. 1 to 7, a coil component 1000 according to a first example embodiment of the present invention may include a body 100, a support member 200, a coil 300, pad portions 410 and 420, via electrodes 510 and 520, and external electrodes 610 and 620.

The body 100 may form the exterior of the coil component 1000 according to the present example embodiment, and the coil 300 may be disposed therein. The coil 300 may be supported by the support member 200, but the present disclosure is not limited thereto.

The body 100 may have an overall hexahedral shape.

The body 100, with respect to the direction of FIG. 1, may have a first surface 101 and a second surface 102 opposing each other in a thickness direction T, a third surface 103 and a fourth surface 104 opposing each other in a width direction W, and a fifth surface 105 and a sixth surface 106 opposing each other in a length direction L. The third to sixth surfaces 103, 104, 105, and 106 of the body 100 may respectively correspond to wall surfaces the first surface 101 and the second surface 102 of the body 100 to each other.

For example, the body 100 may be formed such that the coil component 1000 according to the present example embodiment including the external electrodes 610 and 620 to be described below has a length of 2.5 mm, a width of 2.0 mm, and a thickness of 1.0 mm, has a length of 2.0 mm, a width of 1.2 mm, and a thickness of 1.0 mm, or has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.5 mm, or has a length of 0.8 mm, a width of 0.4 mm, and a thickness of 0.65 mm, but the present disclosure is not limited thereto. The above-described numerical values are merely design values not reflecting a process error, and the like, such that it should be considered that dimensions within a range admitted as a processor error fall within the scope of the present disclosure.

With respect to an optical microscope or scanning electron microscope (SEM) image of a length directional (L)-thickness directional (T) cross-section of a width directional (W) central portion of the coil component 1000, the above-described length of the coil component 1000 may refer to a maximum value among dimensions of a plurality of line segments respectively connecting, to each other, two outermost boundary lines of the coil component 1000 opposing each other in the length direction L illustrated in the image of the cross-section, the plurality of line segments parallel to the length direction L. Alternately, the above-described length of the coil component 1000 may refer to a minimum value among the dimensions of the plurality of line segments respectively connecting, to each other, the two outermost boundary lines of the coil component 1000 opposing each other in the length direction L illustrated in the image of the cross-section, the plurality of line segments parallel to the length direction L. Alternately, the above-described length of the coil component 1000 may refer to an arithmetic mean value of at least three dimensions of the dimensions of the plurality of segments respectively connecting, to each other, the two outermost boundary lines of the coil component 1000 opposing each other in the length direction L illustrated in the image of the cross-section, the plurality of line segments parallel to the length direction L. Here, the plurality of line segments parallel to the length direction L may be equally spaced apart from each other in the thickness direction T, but the present disclosure is not limited thereto.

With respect to the optical microscope or SEM image of the length directional (L)-thickness directional (T) cross-section of the width directional (W) central portion of the coil component 1000, the above-described thickness of the coil component 1000 may refer to a maximum value among dimensions of a plurality of line segments respectively connecting, to each other, two outermost boundary lines of the coil component 1000 opposing each other in the thickness direction T illustrated in the image of the cross-section, the plurality of line segments parallel to the thickness direction T. Alternately, the above-described thickness of the coil component 1000 may refer to a minimum value among the dimensions of the plurality of line segments respectively connecting, to each other, the two outermost boundary lines of the coil component 1000 opposing each other in the thickness direction T illustrated in the image of the cross-section, the plurality of line segments parallel to the thickness direction T. Alternately, the above-described thickness of the coil component 1000 may refer to an arithmetic mean value of at least three dimensions of the dimensions of the plurality of segments respectively connecting, to each other, the two outermost boundary lines of the coil component 1000 opposing each other in the thickness direction T illustrated in the image of the cross-section, the plurality of line segments parallel to the thickness direction T. Here, the plurality of line segments parallel to the thickness direction T may be equally spaced apart from each other in the length direction L, but the present disclosure is not limited thereto.

With respect to the optical microscope or SEM image of the length directional (L)-thickness directional (T) cross-section of the width directional (W) central portion of the coil component 1000, the above-described width of the coil component 1000 may refer to a maximum value among dimensions of a plurality of line segments respectively connecting, to each other, two outermost boundary lines of the coil component 1000 opposing each other in the width direction W illustrated in the image of the cross-section, the plurality of line segments parallel to the width direction W. Alternately, the above-described width of the coil component 1000 may refer to a minimum value among the dimensions of the plurality of line segments respectively connecting, to each other, the two outermost boundary lines of the coil component 1000 opposing each other in the width direction W illustrated in the image of the cross-section, the plurality of line segments parallel to the width direction W. Alternately, the above-described width of the coil component 1000 may refer to an arithmetic mean value of at least three dimensions of the dimensions of the plurality of segments respectively connecting, to each other, the two outermost boundary lines of the coil component 1000 opposing each other in the width direction W illustrated in the image of the cross-section, the plurality of line segments parallel to the width direction W. Here, the plurality of line segments parallel to the width direction W may be equally spaced apart from each other in the length direction L, but the present disclosure is not limited thereto.

Alternatively, each of the length, width, and thickness of the coil component 1000 may be measured by a micrometer measurement method. Each of the length, width, and thickness of the coil component 1000 may be measured using the micrometer measurement method by setting a zero point with a gage repeatability and reproducibility (R&R) micrometer, inserting the coil component 1000 according to the present example embodiment into a tip of the micrometer, and turning a measurement lever of the micrometer. In measuring the length of the coil component 1000 using the micrometer measurement method, the length of the coil component 1000 may refer to a value measured once or an arithmetic mean of values measured multiple times, which may equally be applied to the width and thickness of the coil component 1000.

The body 100 may include an insulating resin and a magnetic material. Specifically, the body 100 may be formed by laminating one or more magnetic composite sheets in which a magnetic material is dispersed in an insulating resin. The magnetic material may be ferrite powder or magnetic metal powder.

The ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, or the like, hexagonal ferrite such as Ba—Zn-based ferrite, Ba—Mg-based ferrite, Ba—Ni-based ferrite, Ba—Co-based ferrite, Ba—Ni—Co-based ferrite, or the like, garnet-type ferrite such as Y-based ferrite or the like, and Li-based ferrite.

The magnetic metal power may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal power may be at least one of pure iron powder, Fe—Si-based alloy power, Fe—Si—Al-based alloy power, Fe—Ni-based alloy power, Fe—Ni—Mo-based alloy power, Fe—Ni—Mo—Cu-based alloy power, Fe—Co-based alloy power, Fe—Ni—Co-based alloy power, Fe—Cr-based alloy power, Fe—Cr—Si-based alloy power, Fe—Si—Cu—Nb-based alloy power, Fe—Ni—Cr-based alloy power, and Fe—Cr—Al-based alloy power.

The magnetic metal powder may be amorphous or crystalline. For example, the magnetic metal powder may be Fe—Si—B—Cr-based amorphous alloy powder, but is not necessarily limited thereto.

Each of the ferrite powder and magnetic metal powder may have an average diameter of about 0.1 μm to about 30 μm, but is not limited thereto.

The body 100 may include two or more types of magnetic materials dispersed in a resin. Here, the different types of magnetic materials mean that magnetic materials dispersed in a resin are distinguished from each other by one of an average diameter, a composition, crystallinity, and a shape.

Hereinafter, it is assumed that the filler is magnetic metal powder, but the scope of the present disclosure is not limited only to the body 100 having a structure in which the magnetic metal powder is dispersed in the insulating resin.

The insulating resin may include, but is not limited to, epoxy, polyimide, liquid crystal polymer, or the like alone or in combination.

Referring to FIGS. 3, 6, and 7, the body 100 may include a core 110 passing through a support member 200 and a coil 300 to be described below. The core 110 may be disposed in a central region of an innermost turn of the coil 300, that is, a central winding region of the coil 300.

The core 110 may be formed by filling a through-hole H, passing through the center of the coil 300 and the center of the support member 200, with a magnetic composite sheet including a magnetic material, but the present disclosure is not limited thereto.

The support member 200 may be disposed in the body 100, and may have a first surface and a second surface opposing each other. The support member 200 may be configured to support the coil 300, and the pad portions 410 and 420 to be described below. In addition, the support member 200 may have a central portion removed through a trimming process to form a through-hole H, and the core 110 may be disposed in the through-hole H. Here, the through-hole H formed in the support member 200 may be formed to have a shape corresponding to the shape of the innermost turn of the coil 300.

The support member 200 may include an insulating material, for example, a thermosetting insulating resin such as an epoxy resin, a thermoplastic insulating resin such as polyimide, or a photosensitive insulating resin, or the support substrate 200 may include an insulating material in which a reinforcing material such as a glass fiber or an inorganic filler is impregnated with an insulating resin. For example, the support substrate 200 may include an insulating material such as prepreg, an Ajinomoto build-up film (ABF), FR-4, a bismaleimide triazine (BT) resin, a photo-imageable dielectric (PID), or the like, but the present disclosure is not limited thereto.

The inorganic filler may be at least one selected from the group consisting of silica (SiO₂), alumina (Al₂O₃), silicon carbide (SiC), barium sulfate (BaSO₄), talc, mud, a mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support substrate 200 is formed of an insulating material including a reinforcing material, the support substrate 200 may provide more excellent rigidity. When the support substrate 200 is formed of an insulating material including no glass fiber, it may be advantageous in reducing a thickness of the coil component 1000 according to the present example embodiment. When the support substrate 200 is formed of an insulating material including a photosensitive insulating resin, the number of processes of forming the coil 300 may be reduced. Thus, it may be advantageous in reducing production costs, and fine vias 321 and 322 may be formed.

The support substrate 200 may have a thickness of, for example, 10 μm to 50 μm, but the present disclosure is not limited thereto.

The coil 300 may be disposed in the body 100 to exhibit properties of the coil component 1000. For example, when the coil component 1000 according to the present example embodiment is used as a power inductor, the coil 300 may serve to stabilize power of an electronic device by storing an electric field as a magnetic field and maintaining an output voltage.

The coil component 1000 according to the present example embodiment may include the coil 300 supported by the support member 200 in the body 100. The coil 300 may have at least one turn wound around the core 110.

Referring to FIGS. 1 to 4, the coil 300 according to the present example embodiment may include first and second coil portions 311 and 312, a first via 321, and first and second extension portions 331 and 332, and may further include a second via 322 connected to the second extension portion 332.

Specifically, the first coil portion 311 and the first extension portion 331 may be disposed on the first surface of the support member 200 opposing the first surface 101 of the body 100, and the second coil portion 312 and the second extension portion 332 may be disposed on the second surface of the support member 200 opposing the second surface 102 of the body 100.

Referring to FIGS. 1, 2, 3, 6, and 7, each of the first coil portion 311 and the second coil portion 312 may have at least one turn using the core 110 as an axis. Each of the first coil portion 311 and the second coil portion 312 may have a planar spiral shape.

The first coil portion 311 may form at least one turn on the first surface of the support member 200 using the core 110 as an axis. The second coil portion 312 may form at least one turn on the second surface of the support member 200 v the core 110 as an axis.

Referring to FIGS. 3 and 6, the coil 300 may include the first via 321 connecting, to each other, the first and second coil portions 311 and 312 disposed on the one side and the other side of the support member 200, respectively. The first via 321 may be disposed to pass through the support member 200, but the present disclosure is not limited thereto.

The first via 321 may electrically connect, to each other, the first and second coil portions 311 and 312 disposed on opposite surfaces of the support member 200. Specifically, with respect to the direction of FIG. 1, a lower surface of the first via 321 may be connected to an end of an innermost turn of the first coil portion 311, and an upper surface of the first via 321 may be connected to an end of an innermost turn of the second coil portion 312.

Referring to FIGS. 3 and 7, the coil 300 may include first and second extension portions 331 and 332 respectively extending from outermost turns of the first and second coil portions 311 and 312. In one embodiment, the first and second extension portions 331 and 332 may be first and second straight portion respectively extending in a straight manner from opposing ends of the coil 300 towards the third surface 103 of the body.

The first extension portion 331 may be disposed on the first surface of the support member 200, and may extend from an end of an outermost turn of the first coil portion 311 to be connected to a first external electrode 610 through a first pad portion 410 and a first via electrode 510 to be described below.

In addition, the second extension portion 332 may be disposed on the second surface of the support member 200, and may extend from an end of an outermost turn of the second coil portion 312 to be connected to the second external electrode 620 through the second via 322, a second portion 420, and a second via electrode 520 to be described below.

Referring to FIGS. 1, 3, and 5, the second via 322 may connect the second extension portion 332 and the second pad portion 420. The second extension portion 332 and the second pad portion 420 may be spaced apart from each other with respect to the support member 200, such that the second extension portion 332 and the second pad portion 420 may be connected through the second via 322 passing through the support member 200.

Here, the second via 322 may be formed integrally with the second extension portion 332. Here, “being formed integrally” may mean that the second via 322 and the second extension portion 332 are formed together in the same process such that there is no interface between the two components, but the present disclosure is not limited thereto.

Referring to FIG. 3, for example, when a signal is input to the first external electrode 610, the input signal may be transmitted to the coil 300 through the first via electrode 510 and the first pad portion 410 to be described below, and may be output to the second external electrode 620 through the second pad portion 420 and the second via electrode 520.

More specifically, the signal input to the first pad portion 410 may be output to the second pad portion 420 through the first extension portion 331, the first coil portion 311, the first via 321, the second coil portion 312, the second extension portion 332, and the second via 322 in sequence.

Thus, the coil 300 may generally function as a single coil between the first and second pad portions 410 and 420.

At least one of the first and second coil portions 311 and 312, the first and second vias 321 and 322, and the first and second extension portions 331 and 332 may include at least one conductive layer.

For example, when the first coil portion 311, the first via 321, and the first extension portion 331 are formed on the first surface of the support member 200 by plating, the first coil portion 311, the first via 321, and the first extension portion 331 may respectively include a seed layer and an electroplating layer. Here, the electroplating layer may have a single-layer structure or a multilayer structure. The electroplating layer of the multilayer structure may be formed to have a conformal film structure in which one electroplating layer is covered with another electroplating layer, and may be formed such that another plating layer is stacked only on one surface of one electroplating layer. The seed layer may be formed by a vapor deposition method such as electroless plating or sputtering. The seed layer of each of the first coil portion 311, the first via 321, and the first extension portion 331 may be formed integrally with each other, such that no boundaries therebetween may be formed, but the present disclosure is not limited thereto. Each of the electroplating layers of the first coil portion 311, the first via 321, and the first extension portion 331 may be formed integrally with each other, such that no boundaries therebetween may be formed, but the present disclosure is not limited thereto.

Each of the first coil portion 311, the first via 321, and the first extension portion 331 may be formed of a conductive material such as copper (Cu), aluminum (Al), silver (Ag), tin (Sn), or gold (Au), nickel (Ni), lead (Pb), titanium (Ti), chromium (Cr), or alloys thereof, but the present disclosure is not limited thereto.

Referring to FIGS. 1 to 3, the coil component 1000 according to the present example embodiment may include the pad portions 410 and 420 disposed on the first surface of the support member 200 to be connected to the coil 300.

The pad portions 410 and 420 may be configured to be disposed before the coil 300 on a lower surface of the support member 200 with respect to the direction of FIG. 1, and thus may function to increase the connection reliability of a mounting surface thereof with the external electrodes 610 and 620 and to facilitate the formation of the via electrodes 510 and 520.

The pad portions 410 and 420 include a first pad portion 410 disposed on the first surface of the support member 200 to be in contact with the first extension portion, and a second pad portion 420 disposed on the first surface of the support member 200. Here, the second pad portion 420 may be connected to the second extension portion 332 on the second surface of the support member 200 through the second via 322 passing through the support member 200.

The second via 322 may be formed after the second pad portion 420 is disposed, such that an interface may be formed in a region in which the second via 322 and the second pad portion 420 are in contact with each other, but the present disclosure is not limited thereto.

Referring to FIGS. 3 to 5, each of the first and second pad portions 410 and 420 may have an upper surface in contact with the first surface of the support member 200 and a lower surface opposing the upper surface, and a lower surface of the first pad portion 410 may be disposed to be in contact with the first extension portion 331 and the first via electrode 510.

Through such a structure, even when the first extension portion 331 and the first via electrode 510 are slightly misaligned between processes, electrical connection reliability may be maintained through the first pad portion 410.

In addition, an upper surface of the second pad portion 420 may be disposed to be in contact with the second via 322, and a lower surface of the second pad portion 420 may be disposed to be in contact with the second via electrode 520.

Through such a structure, even when the second extension portion 332 and the second via electrode 520 are slightly misaligned between processes, electrical connection reliability may be maintained through the second pad portion 420.

In addition, the second via electrode 520 may be electrically connected to the second coil portion 312 without passing through the support member 200, such that the via electrodes 510 and 520 may be formed to have a constant height in a first direction T.

That is, when a via hole for disposing the via electrodes 510 and 520 is processed, the via hole may be formed to have a constant depth so as to reach the pad portions 410 and 420 regardless of whether a region in which the via electrodes 510 and 520 are to be connected to the coil 300 is the first surface or the second surface of the support member 200. Through such a structure, process efficiency may be improved, and open defects may be reduced.

Referring to FIG. 5, a thickness of each of the pad portions 410 and 420 in the first direction T may be smaller than that of the coil 300. On the other hand, a width of each of the pad portions 410 and 420 in a direction orthogonal to the first direction T may be larger than that of the coil 300.

Here, the thickness of each of the pad portions 410 and 420 or the coil 300 may refer to, with respect to an optical microscope or SEM image of an L-T cross-section cut to illustrate the pad portions 410 and 420 or the coil 300, an arithmetic mean value of at least three dimensions of dimensions of a plurality of segments respectively connecting, to each other, two outermost boundary lines of the pad portions 410 and 420 or the coil 300 opposing each other in the thickness direction T, the plurality of line segments parallel to the thickness direction T. Here, the plurality of line segments parallel to the first direction T may be equally spaced apart from each other in the length direction L, but the present disclosure is not limited thereto.

Referring to FIGS. 2 and 3, a step may be formed at an end of the first extension portion 331 in a region in which the first pad portion 410 and the first extension portion 331 are in contact with each other. Such a structure may be a structure resulting from a difference in thickness in the first direction T between the pad portions 410 and 420 and the coil 300. Through the above-described structure, a contact area between the first extension portion 331 and the first pad portion 410 may be increased, thereby improving connection reliability.

The pad portions 410 and 420 may be disposed before the coil 300 on the support member 200 in which a via hole in which the first and second vias 321 and 322 are to be disposed is processed. Therefore, a via hole for forming the first via 321 may be formed to pass through opposite sides of the support member 200. Conversely, a via hole for forming the second via 322 may be formed to pass through opposite sides of the support member 200, and one side among the opposite sides may be blocked by the second pad portion 420.

The pad portions 410 and 420 may be formed through a plating process, and may be formed of a conductive material such as copper (Cu), aluminum (Al), silver (Ag), tin (Sn), gold (Au), nickel (Ni), lead (Pb), titanium (Ti), chromium (Cr), or alloys thereof, but the present disclosure is not limited thereto.

Referring to FIGS. 4 to 6, the coil component 1000 according to the present example embodiment may further include an insulating film IF. The insulating film IF may integrally cover the support member 200, the coil 300, and the pad portions 410 and 420.

Specifically, the insulating film IF may be disposed between the support member 200 and the body 100, between the coil 300 and the body 100, and between the pad portions 410 and 420 and the body 100. The insulating film IF may be formed along a surface of the support member 200 on which the coil portions 311 and 312, the extension portions 331 and 332, and the pad portions 410 and 420 are disposed, but the present disclosure is not limited thereto.

The insulating film IF may fill a space between adjacent turns of the first and second coil portions 311 and 312 and respective spaces between the first and second extension portions 331 and 332 and the first and second coil portions 311 and 312, thereby insulating between coil turns.

The insulating film IF, an insulating film for insulating between the coil 300 and the body 100 and/or between the pad portions 410 and 420 and the body 100, may include a known insulating material such as parylene, but the present disclosure is not limited thereto. As another example, the insulating layer IF may include an insulating material such as an epoxy resin other than parylene. The insulating film IF may be formed by a vapor deposition method, but is not limited thereto. As another example, the insulating film IF may be formed by laminating and curing an insulating film on the support member 200 on which the coil 300 is disposed, and may be formed by applying and curing an insulating paste on opposite surfaces of the support member 200 on which the coil 300 is disposed. For the above-described reason, the insulating film IF may be a component omittable in the present example embodiment. That is, when the body 100 has sufficient electrical resistance at the designed operating current and voltage of the coil component 1000 according to the present example embodiment, the insulating film IF may be a component omittable in the present example embodiment.

Referring to FIGS. 4 and 7, the coil component 1000 according to the present example embodiment may include via electrodes 510 and 520 connecting the pad portions 410 and 420 and the external electrodes 610 and 620 to each other.

Specifically, the first via electrode 510 may connect the first pad portion 410 and the first external electrode 610 to each other, and the second via electrode 520 may connect the second pad portion 420 and the second external electrode 620 to each other.

As a path through which current flows between the external electrodes 610 and 620 on a mounting surface and the coil 300 is reduced, the via electrodes 510 and 520, configured to directly connect between the coil 300 and the external electrodes 610 and 620 in the body 100, may have the effect of reducing R_{dc}, as compared to an L-shaped electrode connected to a side surface of the body 100 and extending to a lower surface of the body 100.

Referring to FIG. 3, the via electrodes 510 and 520 may have an overall cylindrical shape. However, the present disclosure is not limited thereto, and the via electrodes 510 and 520 may be formed to have various shapes such as angled pillars or tapered pillars, as necessary.

Referring to FIG. 4, at least portions of the via electrodes 510 and 520 may extend to be embedded in the pad portions 410 and 420. That is, the via electrodes 510 and 520 may be formed by disposing the pad portions 410 and 420 and the coil 300 on the support member 200 and then laminating a magnetic sheet to form the body 100, and filing a conductive material in a via hole formed using a laser or the like, and thus portions of the via electrodes 510 and 520 may penetrate into the pad portions 410 and 420.

The via electrodes 510 and 520 may require a process of filling a deep via hole through plating. For example, a thin copper (Cu) layer may be formed through pyrophosphoric acid copper plating, and then additional pulse plating may be performed to fill a via hole, but the present disclosure is not limited thereto.

The via electrodes 510 and 520 may include a metal layer. In the present example embodiment, the via electrodes 510 and 520 are formed of a single layer including a metal component, but the present disclosure is not limited thereto, and the via electrodes 510 and 520 may also be formed of a plurality of layers.

The via electrodes 510 and 520 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

Referring to FIGS. 1 to 5, 7, and 8, the first and second external electrodes 610 and 620 may be disposed on the first surface 101 of the body 100 to be spaced apart from each other, and may be connected to the coil 300 through the first and second pad portions 410 and 420, respectively. In one embodiment, the first and second external electrodes 610 and 620 may not disposed on any other surfaces of the body 100 except the first surface 101.

The first and second external electrodes 610 and 620 may be formed by a vapor deposition method such as sputtering and/or a plating method, but the present disclosure is not limited thereto.

The first and second external electrodes 610 and 620 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

The first and second external electrodes 610 and 620 may have a single-layer structure or multilayer structure. For example, the first and second external electrodes 610 and 620 may include a first conductive layer including copper (Cu), a second conductive layer disposed on the first conductive layer, the second conductive layer including nickel (Ni), and a third conductive layer disposed on the second conductive layer, the third conductive layer including tin (Sn). At least one of the second conductive layer and the third conductive layer may be formed to cover the first conductive layer, but the present disclosure is not limited thereto. The first conductive layer may be a plating layer or a conductive resin layer formed by applying and curing a conductive resin including a resin and conductive powder including at least one of copper (Cu) and silver (Ag). The second and third conductive layers may be plating layers, but the present disclosure is not limited thereto.

Referring to FIGS. 4 to 7, the coil component 1000 according to the present example embodiment may include an insulating layer 700 covering the body 100 and exposing the external electrodes 610 and 620.

The insulating layer 700 may be disposed in a region of the first to sixth surfaces 101, 102, 103, 104, 105, and 106 of the body 100 other than a region in which the external electrodes 610 and 620 are disposed.

At least a portion of the insulating layer 700 disposed on the first to sixth surfaces 101, 102, 103, 104, 105, and 106 of the body 100 may be formed in the same process, and thus may be integrally formed such that no boundary is formed therebetween, but the present disclosure is not limited thereto.

The insulating layer 700 may be formed by forming an insulating material for forming the insulating layer 700 by a method such as printing, vapor deposition, spray coating, film lamination, or the like, but the present disclosure is not limited thereto.

The insulating layer 700 may be formed of a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, or the like, a thermosetting resin such as a phenol-based resin, an epoxy-based resin, an urethane-based resin, a melamine-based resin, an alkyd-based resin, or the like, a photosensitive resin, parylene, SiOₓ or SiNₓ. The insulating layer 700 may further include an insulating filler such as an inorganic filler, but the present disclosure is not limited thereto.

### Second and Third Example Embodiments

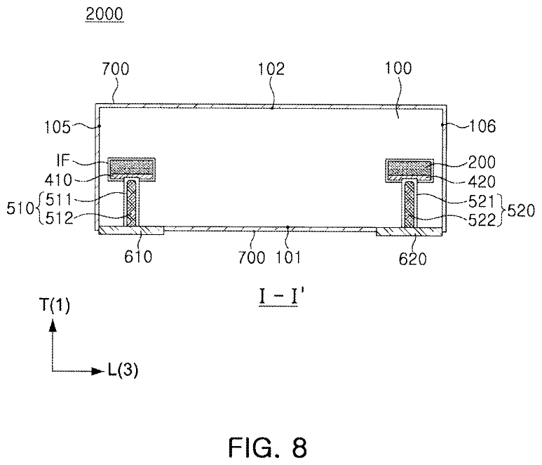

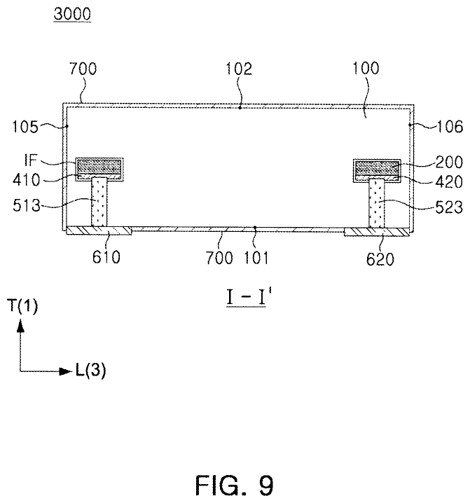

FIG. 8 schematically illustrates a coil component 2000 according to a second example embodiment of the present disclosure, and is a view corresponding to FIG. 4. FIG. 9 illustrates a coil component 3000 according to a third example embodiment of the present disclosure, and is a view corresponding to FIG. 4.

The coil component 1000 according to the first example embodiment may be different from the coil components 2000 and 3000 according to the second and third example embodiments of the present disclosure in terms of specific configurations of the via electrodes 510 and 520.

Accordingly, in describing the present example embodiments, only the via electrodes 510 and 520 different from those of the first example embodiment of the present disclosure will be described. With respect to the other configurations of the present example embodiments, the description of the first example embodiment of the present disclosure may be applicable.

Referring to FIG. 8, in the coil component 2000 according to the second example embodiment of the present disclosure, the via electrodes 510 and 520 may include a plurality of layers.

Specifically, the via electrodes 510 and 520 according to the present example embodiment may include metal layers 511 and 521 in contact with the pad portions 410 and 420, and insulating resin layers 512 and 522 covered by the metal layers 511 and 521, the insulating resin layers 512 and 522 in contact with the external electrodes 610 and 620.

The metal layers 511 and 521 included in a first layer of the via electrodes 510 and 520 may be formed as conformal plating layers through DC plating in a via hole for stable connection with the pad portions 410 and 420. Accordingly, internal voids that may occur may be filled with the insulating resin layers 512 and 522 through a plug process.

The metal layers 511 and 512 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

The insulating resin layers 512 and 522 may be formed of a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, or the like, a thermosetting resin such as a phenol-based resin, an epoxy-based resin, an urethane-based resin, a melamine-based resin, an alkyd-based resin, or the like, a photosensitive resin, parylene, SiOₓ or SiNₓ, but the present disclosure is not limited thereto.

Referring to FIG. 9, the via electrode of the coil component 3000 according to the third embodiment of the present invention may include conductive paste layers 513 and 523.

The conductive paste layers 513 and 523 may be formed of at least one of a solder paste and a carbon-based paste, but the present disclosure is not limited thereto. The conductive paste layers 513 and 523 may be formed of known pastes having conductivity.

While example embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface opposing each other in a first direction;
a support member disposed in the body, the support member having a first surface and a second surface opposing each other;
a coil disposed on the support member;
a pad portion disposed on the first surface of the support member to be connected to the coil;
an external electrode disposed on the first surface of the body; and
a via electrode connecting the pad portion and the external electrode to each other.

2. The coil component of claim 1, wherein a thickness of the pad portion in the first direction is smaller than that of the coil.

3. The coil component of claim 1, wherein the coil includes:
first and second coil portions respectively disposed on the first surface and the second surface of the support member, the first and second coil portions having at least one turn;
a first via passing through the support member to connect the first and second coil portions to each other; and
first and second extension portions respectively extending from outermost turns of the first and second coil portions.

4. The coil component of claim 3, wherein
the pad portion includes a first pad portion disposed on the first surface of the support member to be in contact with the first extension portion, and a second pad portion disposed on the first surface of the support member, and
the coil further includes a second via passing through the support member to connect the second pad portion and the second extension portion to each other.

5. The coil component of claim 4, wherein the second via is formed integrally with the second extension portion.

6. The coil component of claim 4, wherein an interface is formed in a region in which the second via and the second pad portion are in contact with each other.

7. The coil component of claim 4, wherein
the via electrode includes a first via electrode in contact with the first pad portion and a second via electrode in contact with the second pad portion,
each of the first and second pad portions has an upper surface in contact with the first surface of the support member and a lower surface opposing the upper surface,
the lower surface of the first pad portion is in contact with the first extension portion and the first via electrode, and
the upper surface of the second pad portion is in contact with the second via, and the lower surface of the second pad portion is in contact with the second via electrode.

8. The coil component of claim 4, wherein a step is formed in a region of the first extension portion in contact with the first pad portion.

9. The coil component of claim 1, wherein at least a portion of the via electrode extends to be embedded in the pad portion.

10. The coil component of claim 1, wherein the via electrode includes a metal layer.

11. The coil component of claim 1, wherein the via electrode includes a plurality of layers.

12. The coil component of claim 11, wherein the via electrode includes:
a metal layer in contact with the pad portion; and
an insulating resin layer covered by the metal layer, the insulating resin layer in contact with the external electrode.

13. The coil component of claim 1, wherein the via electrode includes a conductive paste layer.

14. The coil component of claim 1, further comprising:
an insulating film covering the support member, the coil, and the pad portion.

15. The coil component of claim 1, further comprising:
an insulating layer covering the body and exposing the external electrode.

16. A coil component comprising:
a body having a first surface and a second surface opposing each other in a first direction, the body further having a third surface connecting the first and second surfaces of the body to each other;
a support member disposed in the body, the support member having a first surface and a second surface opposing each other;
a coil disposed on the first and second surfaces of the support member; and
a first external electrode and a second external electrode disposed on the first surface of the body,
wherein the coil includes a first straight portion and a second straight portion respectively extending from opposing ends of the coil towards the third surface of the body, and
ends of the first and second straight portions are connected to the first and second external electrodes through first and second via electrodes, respectively, that are spaced apart from the third surface of the body.

17. The coil component of claim 16, wherein the coil further includes first and second pad portions disposed on the first surface of the support member at the ends of the first and second straight portions,
the first pad portion is in contact with the first via electrode and the first straight portion,
the second pad portion is in contact with the second via electrode and connected to the second straight portion through a via passing through the support member.

18. The coil component of claim 17, wherein a thickness of the first or second pad portion in the first direction is smaller than that of the coil.

19. The coil component of claim 17, wherein a width of the first or second pad portion in a direction orthogonal to the first direction is larger than that of the coil.

20. The coil component of claim 17, wherein each of the first and second pad portions has an upper surface in contact with the first surface of the support member and a lower surface opposing the upper surface,
the lower surface of the first pad portion is in contact with the first extension portion and the first via electrode, and
the upper surface of the second pad portion is in contact with the via, and the lower surface of the second pad portion is in contact with the second via electrode.

21. The coil component of claim 17, wherein a step is formed in a region of the first straight portion in contact with the first pad portion.

22. The coil component of claim 17, wherein at least a portion of each of the first and second via electrodes extends to be embedded in a corresponding one of the first and second pad portions.

23. A coil component comprising:
a body having a first surface and a second surface opposing each other in a first direction;
a support member disposed in the body;
a coil disposed on the support member;
an external electrode disposed on the first surface of the body; and
a via electrode connecting the coil and the external electrode to each other,
wherein the via electrode includes a metal layer and an insulating resin layer.

24. The coil component of claim 23, further comprising a pad portion disposed on the first surface of the support member at one end of the coil.

25. The coil component of claim 24, wherein the metal layer of the via electrode is in contact with the pad portion and the external electrode, and
the insulating resin layer is disposed in an inner space of the via electrode formed by the metal layer.

26. The coil component of claim 24, wherein a thickness of the pad portion in the first direction is smaller than that of the coil.

27. The coil component of claim 24, wherein at least a portion of the metal layer is embedded in the pad portion.

28. The coil component of claim 23, wherein the resin layer is in contact with the external insulating electrode.

29. The coil component of claim 23, wherein the external electrode is not disposed on any other surfaces of the body except the first surface.
